(19) United States
(12) Patent Application Publication
(10) Pub. No.: US 2010/0095796 A1
(43) Pub. Date: Apr. 22, 2010

(54) RANGE SELECTION APPARATUS

(75) Inventors: Tomoya NAKAMURA, Anjo-shi (JP); Yoshinori SHIBAYAMA, Anjo-shi (JP)

Correspondence Address: SUGHRUE MION, PLLC, 2100 PENNSYLVANIA AVENUE, N.W., SUITE 800, WASHINGTON, DC, 20037, US

(73) Assignee: AISIN AW CO., LTD., Anjo-shi (JP)

(21) Appl. No.: 12/575,748

(22) Filed: Oct. 8, 2009

(30) Foreign Application Priority Data
Oct. 16, 2008 (JP) 2008-267928

(51) Int. Cl. F16H 59/04

(52) U.S. Cl. 74/473.33

(57) ABSTRACT

A range selection apparatus includes a range operating unit for selecting a range, a drive unit that receives information representing the range selected by the range operating unit, and

a range selection activating unit that is shifted to a position corresponding to the range by the drive unit. The apparatus further includes a range selection control unit having a delay unit configured to activate activating elements for shifting to the predetermined range. The delay unit provides a predetermined delay from the time the driver operates a shift lever or the like, thereby alleviating the shock attendant with the range shift.

### BACKGROUND OF THE INVENTION

1. Field of the Invention

The present invention relates to a range selection apparatus configured to shift a range of an automatic transmission mounted on an automotive vehicle and, more specifically, to a range selection apparatus configured to transmit an intension of an operating side such as a shift lever to an activated side as an electric signal, so-called, a shift-by-wire system.

2. Description of the Related Art

In general, an automatic transmission mounted on a vehicle is provided with a hydraulic pressure control apparatus (valve body) on a main body of the automatic transmission, and the hydraulic pressure control apparatus includes a manual valve which shifts ranges (for example, P range, R range, N range, D range, and so on). In contrast, at a driver's seat, a shift lever that a driver operates is arranged and respective range positions selected by the operation of the shift lever are transmitted to the manual valve via mechanical joint means such as a rod.

Recently, a shift-by-wire (SBW) system in which the operation of the driver to the respective ranges is transmitted to a motor (drive unit) via an electric signal and the manual valve is shifted by the motor is devised (see JP-A-2007-271036 (Patent Document 1), for example).

The range selection apparatus employing the mechanical joint means and the range selection apparatus employing the shift-by-wire system both transmit the operation of the shift lever done by the driver directly to the manual valve.

At the time of shift between the R range and the N range (R-N transmission), since a low reverse brake and a reverse clutch both are changed from a released state to an engaged state (N->R transmission) or from the engaged state to the released state (R->N transmission), and hence a shock is generated depending on its timing. In order to alleviate the shock, it is proposed to shift back pressures of a selector valve and an accumulator and shift oil channels via an orifice (See JP-A-7-4511 (Patent Document 2)).

The apparatus configured to alleviate the shock at the time of R-N transmission in Patent Document 2 described above shifts timing of two engaging elements between the case of R->N and the case of N->R, and hence a complicated structure such as shifting of the selector valve and adjustment of the accumulator back pressure by a duty solenoid valve is required, which may cause increase in cost and increase in weight, and may limit its mountability.

In contrast, when the range is shifted from D range to N range (D->N) while traveling in a weak driven state at a second gear speed, even with the range selection apparatus employing the shift-by-wire system, the manual valve is operated simultaneously with the operation of the shift lever, and a forward (D) range pressure is drained, so that both hydraulic servos of a first clutch C-1 and a first brake B-1 as the engaging elements at the second gear speed are simultaneously started to be drained as in the case of the range selection apparatus employing the mechanical joint means as shown in FIG. 6(a). Then, if the first brake B-1 is drained first and the first clutch C-1 is delayed, a state of first gear speed in which the first clutch C-1 engages a one-way clutch F-1 is assumed, so that a shock is generated due to the engagement of the one-way clutch (OWC).

### SUMMARY OF THE INVENTION

Accordingly, it is an object of the present invention to alleviate a shock generated at the time of shifting the range in a simple structure by activating a range selection activating unit at an adequate timing delayed from the operation by the driver using a shift lever or the like by a predetermined period using a range selection apparatus employing a shift-by-wire system.

The present invention provides a range selection apparatus including a range operating unit being able to select a range and issue an instruction of the same, a drive unit configured to receive each range selected by the range operating unit transmitted via an electric signal, and a range selection activating unit configured to be shifted to a position corresponding to the each range by the drive unit, in which

a range selection control unit is interposed in a transmission from the range operating unit to the drive unit via an electric signal, and

the range selection control unit includes a delay unit configured to issue a signal which activates directly at least one of two activating elements required when shifting to a predetermined range via an automatic transmission control unit and issue the signal for causing the shift to the predetermined range to the drive unit after having provided the other one of the activating elements with a delay time enough for the one of the activating elements to be activated.

The activating elements are two engaging elements configured to shift a power transmission path of the automatic transmission,

the range selection activating unit is a manual valve,

the one of the two engaging elements is directly shifted on the basis of the electric signal from the automatic transmission control unit, and

the other one of the two engaging elements is shifted by shifting the manual valve by driving the drive unit after having elapsed the delay time by the delay unit.

Specifically, the range operated by the range operating unit is a shift from a D range to an N range,

the two engaging elements are a first clutch and a first brake engaged at a forward second gear speed,

an engagement pressure of the first clutch is drained by a linear solenoid valve directly on the basis of an N range electric signal from the range operating unit, and

an engagement pressure of the first brake is drained by the manual valve after the first clutch does not have a torque capacity any longer on the basis of the delay time by the delay unit.

The range operated by the range operating unit is a shift from an R range to a P range,

the range selection operating unit is a parking activating mechanism moved in association with the manual valve,

the one of the activating elements is at least one engaging element which engages in the R range, and the other one is a parking lock unit configured to stop an output shaft of the automatic transmission in the P range,

an engagement pressure of the engaging element which engages in the R range is drained by a linear solenoid valve directly on the basis of a P range electric signal from the range operating unit, and

the parking lock unit locks the output shaft by the parking activating mechanism after the shaft torque of the output shaft is released by the release of the engaging element on the basis of the delay time by the delay unit.

According to one aspect of the present invention, with such a simple configuration as to provide the delay unit to the range selection control unit in the range selection apparatus employing the shift-by-wire system, a shock due to the range shift can be alleviated without being associated with cost increase or limit in mounting.

According to another aspect of the present invention, the shock occurred when shifting the range can be alleviated by shifting the timing of engagement or release by shifting one of the two engaging elements for switching the power transmission path of the automatic transmission directly by the electric signal from the automatic transmission control unit and the other one of those by the manual valve after having elapsed the predetermined delay time.

According to still another aspect of the present invention, since the engagement pressure of the first clutch is released directly by the linear solenoid valve and then the first brake is released by the manual valve when shifting the range from the D range to the N range, the shock occurred due to the engagement of the one-way clutch at a first gear speed can be eliminated.

According to yet another aspect of the present invention, since the at least one of the engaging elements which is engaged in the R range is directly released to free the shaft torque applied to the output shaft, and then the output shaft is locked by the parking lock unit by activating the parking activating mechanism via the drive unit for shifting the range from the R range to the P range, so-called a P-release shock can be eliminated.

### BRIEF DESCRIPTION OF DRAWINGS

FIG. 1 shows a skeleton of an automatic transmission to which the present invention is applicable.

FIG. 2 is an activation table thereof.

FIG. 3 schematically shows a hydraulic pressure control apparatus to which the present invention is applicable.

FIG. 4 is a schematic drawing showing a range selection apparatus according to the present invention.

FIG. 5 is a flowchart showing a D->N operation according to the present invention.

FIG. 6 is a time chart of FIG. 5, in which (a) shows a related art, and (b) shows an embodiment of the present invention.

FIG. 7 is a flowchart showing an R->P operation according to the present invention.

FIG. 8 is a time chart of FIG. 7, in which (a) shows the related art, and (b) shows the embodiment of the present invention.

### DESCRIPTION OF THE PREFERRED EMBODIMENTS

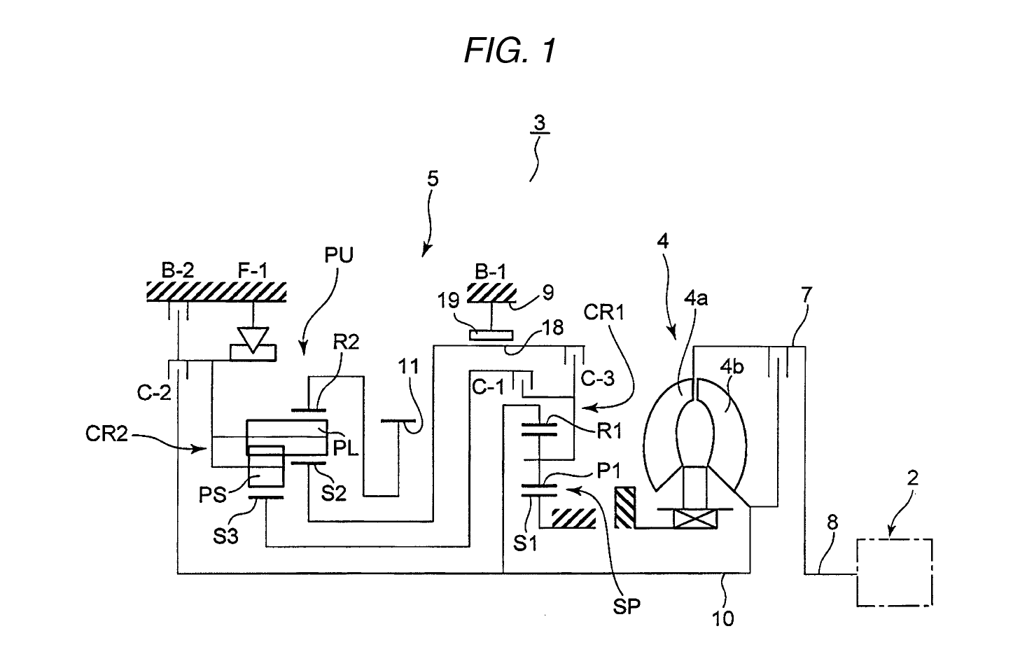

Referring now to the drawings, an embodiment according to the present invention will be described. First of all, a schematic configuration of an automatic transmission 3 to which the present invention is applicable will be described with reference to FIG. 1. As shown in FIG. 1, for example, the automatic transmission 3 which is suitable to be used in a vehicle of FF type (Front engine Front drive), for example, includes an input shaft 8 of the automatic transmission 3 which can be connected to an engine (drive source) 2, and includes a torque converter 4 and an automatic transmission mechanism 5 with the axial direction of the input shaft 8 as a center.

The torque converter 4 includes a pump impeller 4a connected to the input shaft 8 of the automatic transmission 3 and a turbine runner 4b to which the rotation of the pump impeller 4a is transmitted via working fluid, and the turbine runner 4b is connected to an input shaft 10 of the automatic transmission mechanism 5 disposed coaxially with the input shaft 8. The torque converter 4 is provided with a lock up clutch 7 and, when the lockup clutch 7 is engaged, the rotation of the input shaft 8 of the automatic transmission 3 is directly transmitted to the input shaft 10 of the automatic transmission mechanism 5.

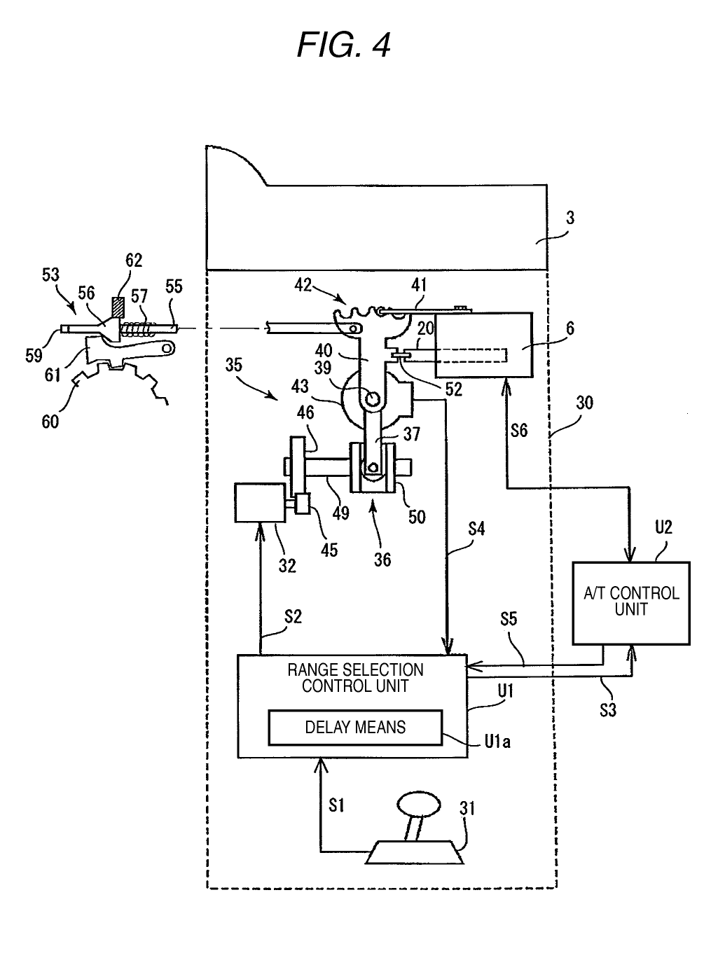

The automatic transmission mechanism 5 includes clutches C-1, C-2, C-3, brakes B-1, B-2 engaged with respective hydraulic servos C . . . , B . . . (see FIG. 4) on the basis of engagement pressure supplied respectively thereto, the input shaft 10 connected to the engine 2, and a counter gear 11 connected to a driving wheel, not shown, and is configured to define a plurality of transmission speeds by changing a transmission path between the input shaft 10 and the counter gear 11 on the basis of the engaged state between the clutches C-1, C-2, C-3, and the brakes B-1, B-2, and the automatic transmission mechanism 5 includes a planetary gear SP and a planetary gear unit PU on the input shaft 10. The planetary gear SP described above is so-called a single pinion planetary gear including a sun gear S1, a carrier CR1, and a ring gear R1, and the carrier CR1 includes a pinion P1 which engages the sun gear S1 and the ring gear R1.

The planetary gear unit PU is so-called a Ravigneaux type planetary gear including a sun gear S2, a sun gear S3, a carrier CR2, and a sun gear R2 as four rotating elements, and the carrier CR2 includes a long pinion PL engaging the sun gear S2 and the ring gear R2, and a short pinion PS engaging the sun gear S3 in a state of being engaged with each other.

The sun gear S1 of the planetary gear SP described above is connected to a boss portion integrally fixed to a transmission case 9 so as to be fixed from rotation. Also, the ring gear R1 described above is configured to rotate in the same direction as the rotation of the input shaft 10 (hereinafter, referred to as “input rotation”). The carrier CR1 is configured to perform a decelerated rotation which is the input rotation decelerated by the fixed sun gear S1 and the ring gear R1 which performs the input rotation, and is connected to the clutch (frictionally engaging element) C-1 and the clutch (frictionally engaging element) C-3.

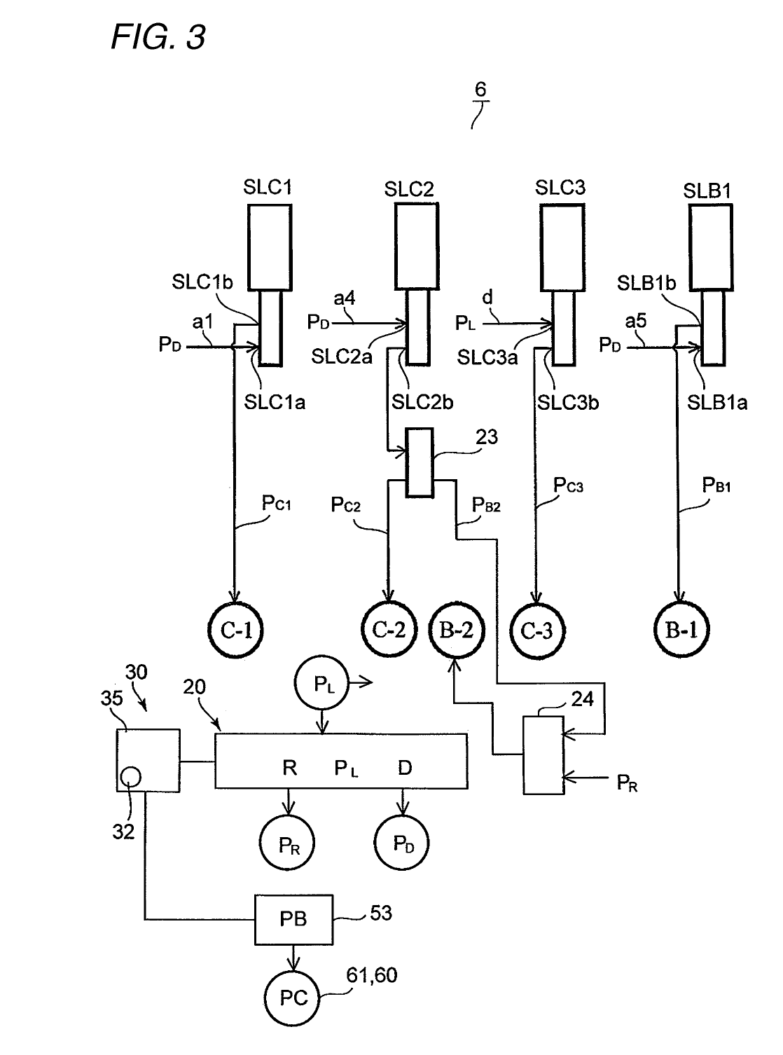

The sun gear S2 of the planetary gear unit PU is connected to the brake B-1 composed of a strap brake and freely fixable with respect to a transmission case and is connected to the clutch C-3, so that the decelerated rotation of the carrier CR1 is inputted freely via the clutch C-3. The sun gear S3 is connected to the clutch C-1, so that the decelerated rotation of the carrier CR1 is inputted freely. The brake B-1 includes a brake band 19 provided around the periphery of a drum-state member 18 connected to the clutch C-3 and the sun gear S2, and the brake band 19 is fixed at one end thereof to the case 9, and at the other end connected to the hydraulic servo B-1 (see FIG. 3), described later, to be driven, so as to be wound around the drum-state member 18 by the drive of the hydraulic servo B-1. The direction of winding of the brake band 19 is adapted to be an opposite direction from the direction of rotation of the drum-state member 18 from the forward second gear speed to a forward sixth gear speed, that is, is configured to be wound by being pulled in the direction opposite from the direction of rotation (in the self-winding direction) from the forward second gear speed to the forward sixth gear speed of the drum-state member 18 by the hydraulic servo B-1. The respective clutches and the brakes and the hydraulic servos which activate the same are designated by the same reference numerals and signs because the operation is the same. In the present invention, the clutch and the brake are expressed as an engaging element, and engaging elements includes the hydraulic servo thereof. For example, the engagement between predetermined engaging element (for example, clutch C-1, brake B-1) means that the clutch C-1 or the brake B-1 as a frictional element is engaged (tightened) by the hydraulic servos C-1 or B-1 supplied with a hydraulic pressure.

In addition, the carrier CR2 is connected to the clutch C-2 which receives an input of the rotation of the input shaft 10, and is freely inputted with the input rotation via the clutch C-2, and is also connected to an one-way clutch F-1 and the brake B-2 so as to be restrained in rotation in the one direction with respect to the transmission case via the one-way clutch F-1 and to be freely fixed from the rotation via the brake B-2. Then, the ring gear R2 is connected to the counter gear (output shaft) 11, and the counter gear 11 is connected to the driving wheel, not shown, via a counter shaft and a differential apparatus, not shown.

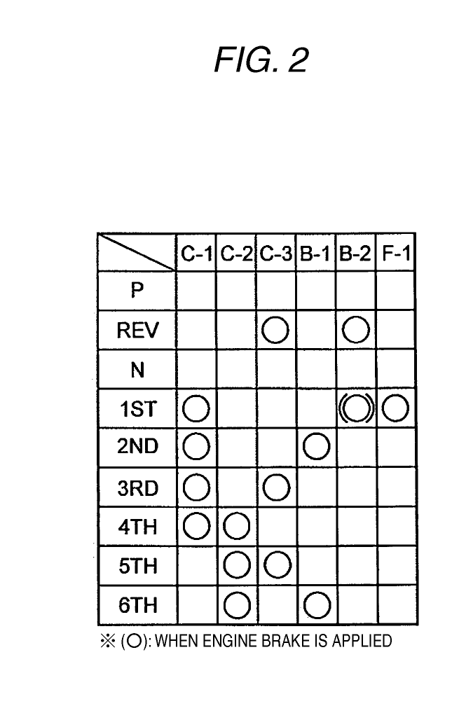

Subsequently, on the basis of the configuration as described above, an operation of the automatic transmission mechanism 5 will be described with reference to an activation table in FIG. 2.

For example, in the forward first drive speed (1ST) in D (Drive) range, the (first) clutch C-1 and the one-way clutch F-1 are engaged. Then, the rotation of the carrier CR1 which performs the decelerated rotation by the fixed sun gear S1 and the ring gear R1 which performs the input rotation is inputted to the sun gear S3 via the clutch C-1. Then, the rotation of the carrier CR2 is restrained to one direction (the direction of normal rotation), that is, the carrier CR2 is prevented from performing a reverse rotation and is brought into a fixed state. Then, the decelerated rotation inputted to the sun gear S3 is outputted to the ring gear R2 via the fixed carrier CR2, and the normal rotation as the forward first gear speed is outputted from the counter gear 11.

Also, when an engine brake is applied (coast), the state of the forward first gear speed is maintained in the form of locking the brake B-2 to fix the carrier CR2, and preventing the normal rotation of the carrier CR2. Also, in the forward first gear speed, the reverse rotation of the carrier CR2 is prevented and the normal rotation is enabled by the one-way clutch F-1, and hence achievement of the forward first gear speed when shifting the range from the non-traveling range to the traveling range can be performed smoothly by an automatic engagement of the one-way clutch F-1.

At the forward second gear speed (2ND), the (first) clutch C-1 is engaged, and the (first) brake B-1 is locked. Then, the rotation of the carrier CR1 which performs the decelerated rotation by the fixed sun gear S1 and the ring gear R1 which performs the input rotation is inputted to the sun gear S3 via the clutch C-1. Also, the rotation of the sun gear S2 is fixed by the locking of the brake B-1. Then, the carrier CR2 performs the decelerated rotation, which is a lower speed rotation than the sun gear S3, and the decelerated rotation inputted to the sun gear S3 is outputted to the ring gear R2 via the carrier CR2, and the normal rotation as the forward second gear speed is outputted from the counter gear 11.

At a forward third gear speed (3RD), the clutch C-1 and the clutch C-3 are engaged. Then, the rotation of the carrier CR1 which performs the decelerated rotation by the fixed sun gear S1 and the ring gear R1 which performs the input rotation is inputted to the sun gear S3 via the clutch C-1. Also, the decelerated rotation of the carrier CR1 is inputted to the sun gear S2 by the engagement of the clutch C-3. In other words, since the decelerated rotation of the carrier CR1 is inputted to the sun gear S2 and the sun gear S3, the planetary gear unit PU is in the directly connected state at the decelerated rotation, the decelerated rotation is outputted to the ring gear R2 without change, and the normal rotation as the forward third gear speed is outputted from the counter gear 11.

At a forward fourth gear speed (4TH), the clutch C-1 and the clutch C-2 are engaged. Then, the rotation of the carrier CR1 which performs the decelerated rotation by the fixed sun gear S1 and the ring gear R1 which performs the input rotation is inputted to the sun gear S3 via the clutch C-1. Also, the input rotation is inputted to the carrier CR2 by the engagement of the clutch C-2. Then, a decelerated output which is caused by the decelerated rotation inputted to the sun gear S3 and the input rotation inputted to the carrier CR2 to be higher than the forward third gear speed described above is outputted to the ring gear R2, and the normal rotation as the forward fourth gear speed is outputted from the counter gear 11.

At a forward fifth gear speed (5TH), the clutch C-2 and the clutch C-3 are engaged. Then, the rotation of the carrier CR1 which performs the decelerated rotation by the fixed sun gear S1 and the ring gear R1 which performs the input rotation is inputted to the sun gear S2 via the clutch C-3. Also, the input rotation is inputted to the carrier CR2 by the engagement of the clutch C-2. Then, a speed-increased rotation which is caused by the decelerated rotation inputted to the sun gear S2 and the input rotation inputted to the carrier CR2 to be slightly higher than the input rotation is outputted to the ring gear R2, and the normal rotation as the forward fifth gear speed is outputted from the counter gear 11.

At the forward sixth gear speed (6TH), the clutch C-2 is engaged, and the brake B-1 is locked. Then, the input rotation is inputted to the carrier CR2 by the engagement of the clutch C-2. Also, the rotation of the sun gear S2 is fixed by the locking of the brake B-1. Then, the input rotation of the carrier CR2 is outputted to the ring gear R2 as a speed-increased rotation higher than the forward fifth gear speed by the fixed sun gear S2, and the normal rotation as the forward sixth gear speed is outputted from the counter gear 11.

At a reverse gear speed (REV), the clutch C-3 is engaged and the brake B-2 is locked. Then, the rotation of the carrier CR1 which performs the decelerated rotation by the fixed sun gear S1 and the ring gear R1 which performs the input rotation is inputted to the sun gear S2 via the clutch C-3. Also, the rotation of the carrier CR2 is fixed by the locking of the brake B-2. Then, the decelerated rotation inputted to the sun gear S2 is outputted to the ring gear R2 via the fixed carrier CR2, and the reverse rotation as the reverse gear speed is outputted from the counter gear 11.

For example, in a P (parking) range and an N (neutral) range, the clutch C-1, the clutch C-2, the clutch C-3 are released. Then, a state between the carrier CR1 and the sun gear S2 and the sun gear S3, that is, a state between the planetary gear SP and the planetary gear unit PU is brought into a disconnected state, and a state between the input shaft 10 and the carrier CR2 is brought into the disconnected state. Accordingly, the power transmission between the input shaft and the planetary gear unit PU is brought into the disconnected state, that is, the power transmission between the input shaft 10 and the counter gear 11 is brought into the disconnected state.

Subsequently, a hydraulic pressure control apparatus 6 of the automatic transmission according to the present invention will be described with reference to FIG. 3. First of all, portions which generate a line pressure, a secondary pressure, a modulator pressure, a range pressure, and the like in the hydraulic pressure control apparatus 6, which are omitted from illustration, will be described briefly.

The hydraulic pressure control apparatus 6 includes, for example, an oil pump, a manual shift valve, a primary regulator valve, a secondary regulator valve, a solenoid modulator valve, and a linear solenoid valve, not shown. For example, when the engine 2 is started, the oil pump coupled to the pump impeller 4a of the torque converter 4 described above so as to be driven to rotate is driven in conjunction with the rotation of the engine 2, so that the hydraulic pressure is generated by sucking oil from an oil pan, not shown, via a strainer.

The hydraulic pressure generated by the oil pump is adjusted to a line pressure P_{L} while being adjusted in discharge by the primary regulator valve on the basis of a signal pressure of the linear solenoid valve adjusted and outputted according to the throttle opening. This line pressure P_{L} is supplied to the manual shift valve, the solenoid modulator valve, and the linear solenoid valve, which will be described later in detail, and so on. The line pressure P_{L} supplied to the solenoid modulator valve among these valves is adjusted to a modulator pressure which is maintained at a substantially constant value by the valve, and the modulator pressure is supplied as an original pressure of the linear solenoid valve.

The pressure discharged from the primary regulator valve is adjusted to a secondary pressure while being further adjusted in discharge by, for example, a secondary regulator valve, and the secondary pressure is supplied, for example, to a lubricant channel, an oil cooler, and the like and is supplied also to the torque converter 4, and simultaneously is used for controlling the lock up clutch 7.

In contrast, a manual valve 20 includes a spool operated in electrical conjunction with the shift lever provided at a driver's seat (not shown) by a range selection apparatus 30 employing a shift-by-wire system, which will be described later with reference to FIG. 4, and sets the output state of the inputted line pressure P_{L}, or the non-output state (drain) by the position of the spool being shifted according to the shift ranges (for example, P, R, N, D) selected by the shift lever.

More specifically, when the D range is selected by the operation of the shift lever, an input port to which the line pressure P_{L} is inputted on the basis of the position of the spool and a forward (D) range pressure output port are brought into communication with each other, and the line pressure P_{L} is outputted as a forward range pressure (D range pressure) P_{D} from the forward range pressure output port. When the R (reverse) range is selected by the operation of the shift lever, the input port and a reverse range pressure output port are brought into communication with each other on the basis of the position of the spool, and the line pressure P_{L} is outputted as a reverse range pressure (R range pressure) P_{R} from the reverse range pressure output port. Also, when the P range and the N range are selected by the operation of the shift lever, a communication of the input port with respect to the forward range pressure output port and the reverse range pressure output port is blocked by the spool, and the forward range pressure output port and the reverse range pressure output port are brought into communication with a drain port, that is, the non-output state in which the D range pressure P_{D} and the R range pressure P_{R} are drained (discharged) is assumed.

Subsequently, a portion which mainly performs a transmission control in the hydraulic pressure control apparatus 6 according to the present invention will be described. FIG. 3 is a schematically showing circuit diagram extracted from the hydraulic pressure control apparatus 6 of the automatic transmission. The hydraulic pressure control apparatus 6 includes four linear solenoid valves SLC1, SLC2, SLC3, and SLB1 for supplying an output pressure, which is adjusted as the engagement pressure, directly respectively to five hydraulic servos in total; that is, to the hydraulic servo C-1 of the clutch C-1, the hydraulic servo C-2 of the clutch C-2, the hydraulic servo C-3 of the clutch C-3, the hydraulic servo B-1 of the brake B-1, the hydraulic servo B-2 of the brake B-2 respectively. It achieves a limp-home function and includes selector valves 23, 24 which shift the output pressure of the linear solenoid valve SLC2 to the hydraulic servo C-2 of the clutch C-2 or the hydraulic servo B-2 of the brake B-2 described above. These selector valves are the C2 apply relay valve 23 and the B2 relay valve 24 operated respectively by the solenoid valve, and are relevant to other valves as well. However, they are omitted as well as other valves from description.

A forward range pressure output port D of the manual valve 20 described above is connected to an oil channel a1 to the linear solenoid valve SLC1, an oil channel a4 to the linear solenoid valve SLC2, and an oil channel a5 to the linear solenoid valve SLB1 so as to allow an input of the forward range pressure P_{D}, and the line pressure P_{L} from the primary regulator valve (not shown) is inputted to an oil channel d to the linear solenoid valve SLC3.

The linear solenoid valve SLC1 described above is of a normal close type which assumes the non-output state when not being energized, and includes an input port SLC1a configured to input the forward range pressure P_{D} via the oil channel a1 and an output port S_{LC1b} configured to adjust the forward (D) range pressure P_{D} and output a controlled pressure P_{SLC1} to the hydraulic servo C-1 as an engagement pressure P_{C1}.

The linear solenoid valve SLC2 is of a normal open type which assumes the output state when not being energized, and includes an input port SLC2a configured to input the forward (D) range pressure P_{D} via the oil channel a4 and an output port SLC2b configured to adjust the forward (D) range pressure P_{D} and output a controlled pressure P_{SLC2} to the hydraulic servo C-2 as an engagement pressure P_{C2} (or engagement pressure P_{BZ}).

The linear solenoid valve SLC3 described above is of a normal open type which assumes the output state when not being energized, and includes an input port SLC3a configured to input the line pressure P_{L} via the oil channel d and an output port SLC3b configured to adjust the line pressure P_{L} and output a controlled pressure P_{SLC3} to the hydraulic servo C-3 as an engagement pressure P_{c3}.

The linear solenoid valve SLB1 is of a normal close type which assumes the non-output state when not being energized, and includes an input port SLB1a configured to input the forward (D) range pressure P_{D} via the oil channel a5 and an output port SLB1b configured to adjust the forward range pressure P_{D} and output a controlled pressure P_{SLB1} to the hydraulic servo B-1 as an engagement pressure P.

The first selector valve 23 is a valve configured to switch the engagement pressure of the linear solenoid valve SLC2 between an engagement pressure P_{C2} to the hydraulic servo C-2 and an engagement pressure P_{B2} to the hydraulic servo B-2. The second selector valve 24 is a valve configured to switch a supply pressure to the hydraulic servo B-2 between the reverse range pressure P_{R} from the manual valve 20 and the engagement pressure P_{B2} from the first selector valve 23.

The range selection apparatus 30 employing the shift-by-wire system is configured to be used in the automatic transmission as a power transmission apparatus to be mounted on the vehicle (for example, a multi-stage automatic transmission or a stepless transmission (CVT)) 3 as shown in FIG. 4, and includes a shift lever 31 as an operating unit which the driver can select the shift range (P, R, N, D) and issue command, a driving mechanism (driving unit) 35 configured to perform a control to switch the shift range by mainly controlling the drive of the motor 32 on the basis of the electric signal (shift signal) S1 from the shift lever 31, and the manual valve 20 which is the spool to set the shift range (P, R, N, D) according to the range position at a plurality of the range positions of the driving mechanism 35 with respect to the hydraulic pressure control apparatus 6 of the automatic transmission 3. Also, the signal S1 of the shift lever 31 is transmitted to a range selection control unit U1, and is transmitted to the motor 32 of the driving mechanism 35 as the signal S2 after a predetermined processing actions according to the present invention. To the range selection control unit U1, which is described later in detail, an automatic transmission (A/T) control unit U2 which performs a transmission control (for example, control of engagement of the clutch or the brake) of the automatic transmission 3 upon reception of an authorization signal from the range selection control unit U1.

The shift lever 31 (range operating unit) is a lever configured to select a required range to which the driver wants to set the automatic transmission 3 by operating by himself or herself. The shift lever 31 is provided with an indication of the respective transmission modes of P (parking) range, R (reverse) range, N (neutral) range, and D (drive) range of the automatic transmission 3. Then, the shift signal S1 corresponding to the required range which is selected and set is inputted to the range selection control unit U1, described later in detail. In addition to the ranges described above, the shift lever 31 may have manual operation ranges (shifts) which are operated to the forward first to sixth gear speeds via an operation of a different system from the D range (for example, an operation toward the side once and then to upward or downward in the vertical direction), and the manual operation ranges in this case are also included in the range operation.

The shift lever 31 may be replaced by the one other than the shift lever 31 as long as it can reflects the intention of the driver, that is, as long as it can generate the shift signal S1 corresponding to the required range selected by the driver. For example, a shift switch, a shift button, or a speech input apparatus or the like may be used.

The driving mechanism 35 includes a ball screw mechanism 36 configured to transform a rotational movement of the motor to a linear movement, an arm member 37 configured to transform the linear movement of the ball screw mechanism 36 to a pivotal movement, a manual shaft 39 configured to be driven by the pivotal movement of the arm member 37 to rotate, and a detent mechanism 42 having a detent lever 40 fixed and connected to the manual shaft 39 and a detent spring 41 configured to urge the detent lever 40 to an angle corresponding to the shift range, and the spool of the manual valve 20 is connected to the detent lever 40 of the detent mechanism 42. A positional sensor (position detecting unit) 43 configured to detect the position of the manual valve 20 by detecting an angle of the manual shaft 39 is provided at an end of the manual shaft 39.

An output gear 45 is fixed to an output shaft of the motor 32, so that a transmission is achieved from the output gear 45 to a gear 46 to rotate the ball screw shaft 49. In this embodiment, the ball screw mechanism 36 is employed for transforming the rotation of the gear 45 to a reciprocal movement. The ball screw mechanism 36 includes a number of balls, not shown, interposed between the ball screw shaft 49 and a ball nut 50 so as to be capable of circulating, and the ball nut 50 is engaged with the ball screw shaft 49 so as to be capable of moving in the axial direction.

The detent lever 40 pushes and pulls a hook 52, and moves the spool of the manual valve 20 to a position in the axial direction. A parking activating mechanism 53 is connected to a midsection of the detent lever 40. The parking activating mechanism 53 includes a parking rod 55 connected thereto so as to move integrally with the manual valve 20 via the detent lever 40, and the parking rod 55 includes a parking cam 56 supported so as to be slidable and urged toward a stopper 59 by a spring 57. In contrast, the output shaft of the automatic transmission includes a parking gear 60 integrally fixed thereto, and a parking pole 61 disposed so as to oppose this gear. By the movement of the parking cam 56 via the parking rod 55, the parking pole 61 engages the parking gear 60 between a support 62 and the parking gear 60 to lock the output shaft. The integrally moving manual value (specifically, the spool thereof) 20 and the parking activating mechanism (specifically, the parking rod) 53 correspond to the range selection activating unit, and the respective clutches, brakes (and the hydraulic servos thereof) C . . . , B . . . , and the parking pole 61 and the parking gear 60 (parking lock unit) correspond to activating elements operated when shifting to the predetermined range.

The range selection control unit U1 inputs the signal S1 from the shift lever 31 and outputs the signal to the motor 32 and the A/T control unit U2 from the driving mechanism 35, and also inputs a position signal S4 of the each range from the positional sensor 43 and inputs the selection signal of the each valve and other signals S5 from the A/T control unit U2. The A/T control unit inputs and outputs a signal S6 with respect to the hydraulic pressure control apparatus 6.

Then, the range selection control unit U1 includes a delay unit U1a configured to output the signal S3 corresponding to the each range directly to the A/T control unit U2 on the basis of the signal S1 from the shift lever 31 and output the signal S2 to the driving mechanism 35 with a delay from the signal S3 by a predetermined period corresponding to the each range so as to be built therein.

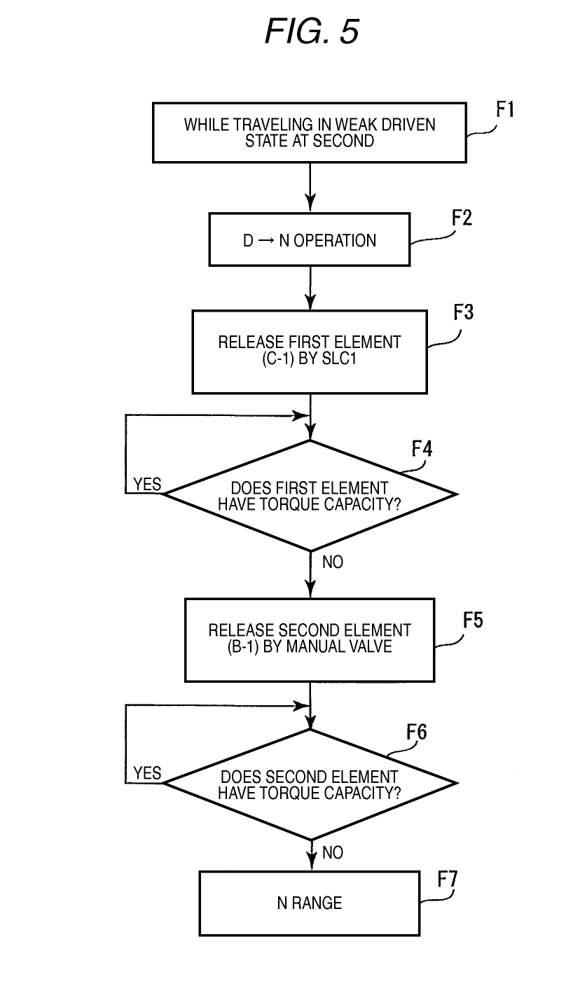

An activation of the range selection apparatus 30 having the delay unit U1a will be described with reference to FIG. 5 to FIG. 8.

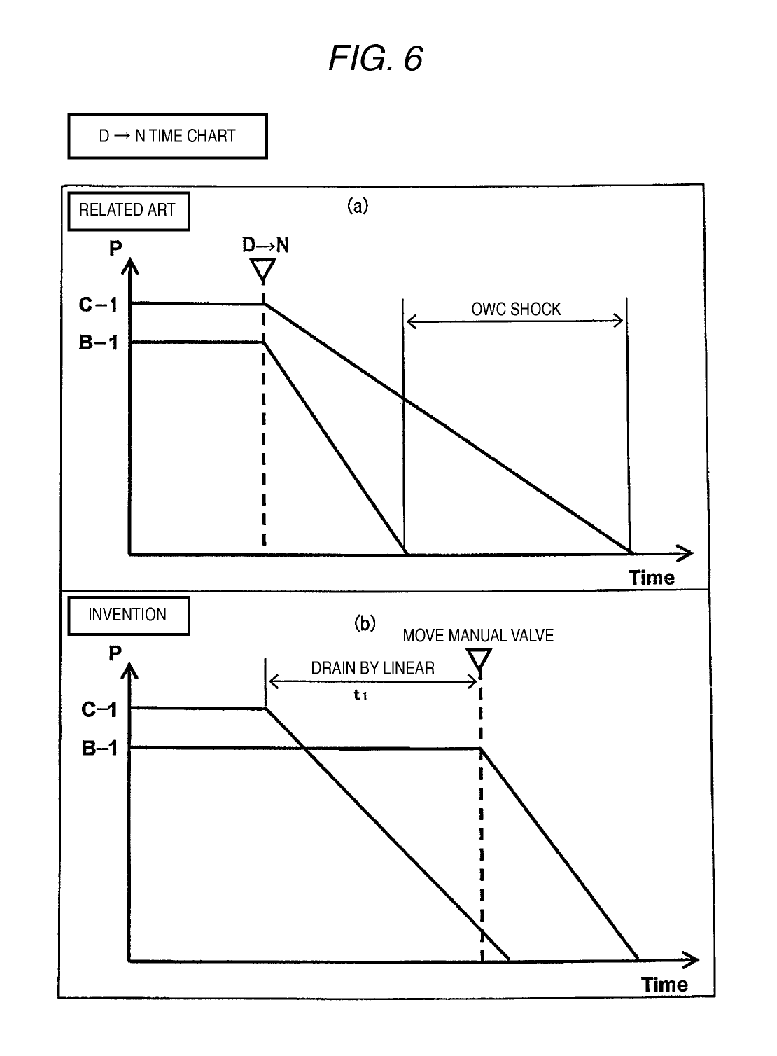

First of all, a case where the driver operates the shift lever 31 from the D range to the N range (D->N) while traveling in a weak driven state at the second gear speed will be described with reference to FIG. 5 and FIG. 6. In the related art, as shown in FIG. 6(a), the manual valve 20 is shifted and the forward (D) range pressure as the original pressure is drained, so that the both hydraulic servos of the first clutch C-1 and the first brake B-1 are simultaneously started to be drained. In this case, if the draining speed of the brake B-1 is faster than the draining speed of the clutch C-1, a state of the first gear speed in which the clutch C-1 engages the one-way clutch F-1 is assumed, and a shock is generated in association with the engagement of the one-way clutch (OWC).

According to the embodiment of the present invention, as shown in FIG. 5 and FIG. 6(b), when the driver operates the shift lever 31 to the N range (F2) during the travel in the weak driven state at the forward second gear speed, in other words, while traveling in the state in which the first clutch C-1 and the first brake B-1 are engaged (F1), the signal S1 is sent to the range selection control unit U1. In the range selection control unit U1, the signal S3 is issued to the A/T control unit U2 immediately on the basis of the signal S1. Accordingly, the A/T control unit U2 turns the linear solenoid valve SLC1 of the hydraulic pressure control apparatus 6 ON to block a supply of the forward (D) range pressure P_{D} to the output port SLC1b via the oil channel a1, and drains the engagement pressure P_{C1} of the hydraulic servo C-1 (F3). Accordingly, the engagement torque capacity of the clutch C-1 is gradually reduced, so that the torque capacity is disappeared (F4).

Determination whether or not the clutch C-1 has the torque capacity (the determination in flow step F4) is achieved by providing a plurality of maps for respective oil temperatures, setting a predetermined delay time on the basis of the map corresponding to the detected oil temperature by the hydraulic pressure sensor (not shown), and observing the elapse of the delay time. The delay unit U1a of the range selection control unit is not limited to the one on the basis of the delay time set by the map, and may be other means such as detecting the hydraulic pressure of the hydraulic servo C-1 or detecting the rotational ratio on the output side of the clutch C-1.

The range selection control unit U1 outputs the signal S2 to the motor 32 of the driving mechanism 35 after having elapsed the delay time t₁ which is enough to determine that the clutch C-1 does not have the torque capacity on the basis of the delay unit U1a, and drives the driving mechanism 35 to shift the manual valve to the N range position. Accordingly, the D range port of the manual valve is drained, and hence the forward (D) range pressure as the original pressure is drained, so that the hydraulic servo B-1 is released even though the linear solenoid valve SLB1 is at the supply position (F5).

When the torque capacity of the brake B-1 is reduced and a predetermined period is elapsed, the brake is released and is positioned in the N range (F6, F7). Accordingly, the clutch C-1 is released firstly while the brake B-1 is in the engaged state even though the operation of the shift lever from D to N is made while traveling at the second gear speed, the first gear speed is not passed and hence the shock due to the engagement with the one-way clutch F-1 is avoided.

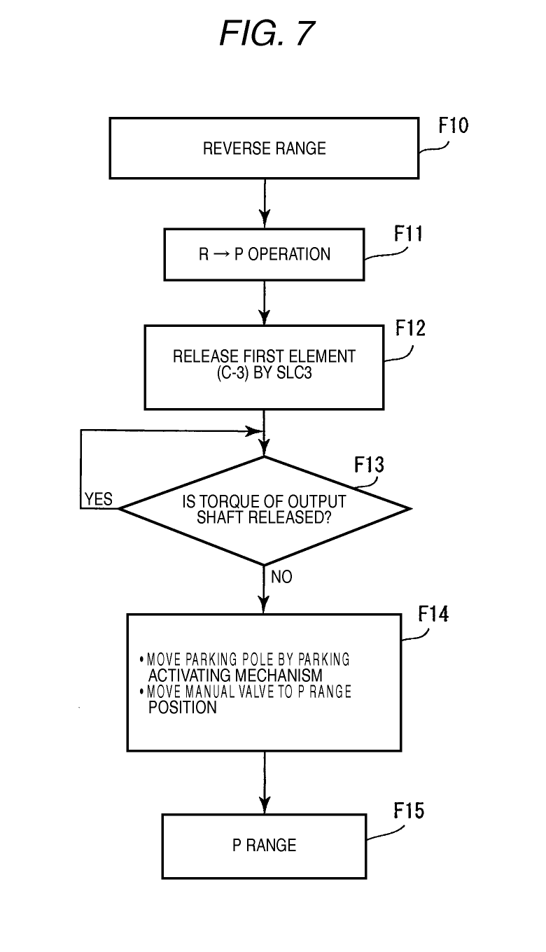

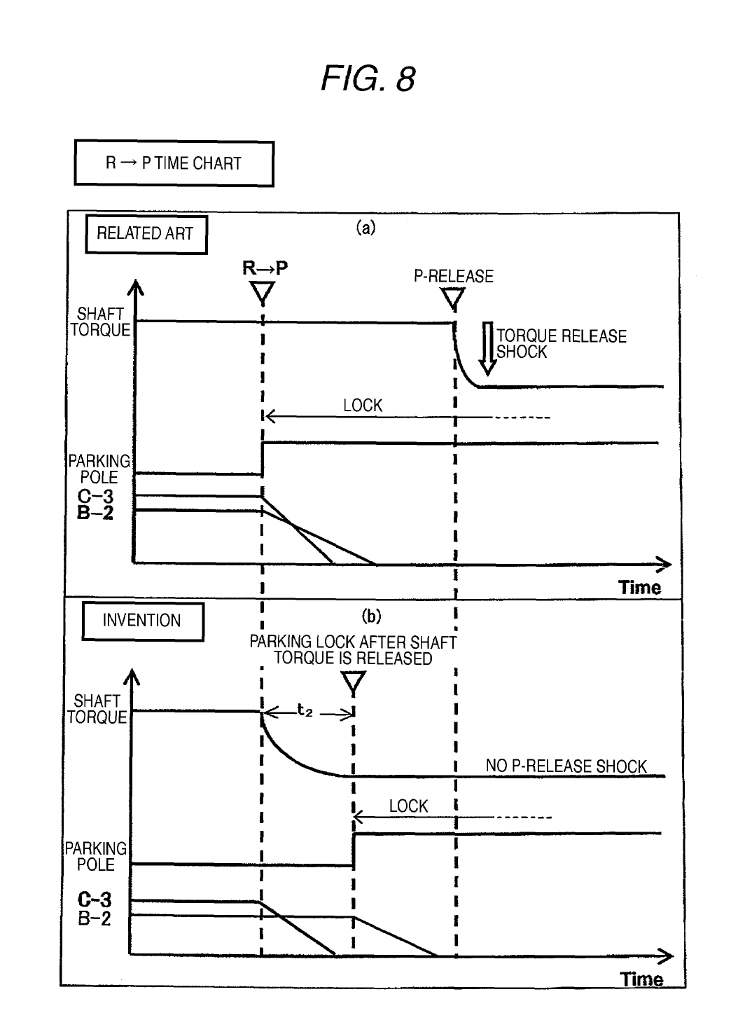

Subsequently, a case of operating from the R range to the P range will be described with reference to FIG. 7 and FIG. 8. In the related art, the clutch C-3 engages the brake B-2 and the output shaft is reversely rotated to rotate the wheels to the reversed direction in the R range as shown in FIG. 8(a). If the shift lever 31 is operated to the P range (R->P) in this state, the reverse (R) range pressure as the original pressure is released and, simultaneously, the parking activating mechanism 53 is activated to engage (lock) the parking pole 61 with the parking gear 60. In this state, the shaft torque on the basis of the reverse travel is applied to the output shaft. Then, when the servo hydraulic pressure of the clutch C-3 and the servo hydraulic pressure of the brake B-2 are released and the clutch and the brake are released, the shaft torque applied to the output shaft is also released, and a torque release shock is generated at this time. Release of the clutch C-3 and the brake B-2 is started at the same timing as the R->P operation of the shift lever, but the hydraulic pressure of the clutch C-3 is released prior to the brake B-2, and the parking (P) range is assumed.

According to the embodiment of the present invention, the driver operates the shift lever 31 (F11) to the parking (P) range while reversely traveling in the reverse range or while being stopped (F10) as shown in FIG. 7 and FIG. 8(b). Then, the P range electric signal S1 from the shift lever 31 is inputted to the range selection control unit U1, and this signal is outputted as the electric signal S3 to the A/T control unit U2 immediately. The A/T control unit U2 issues the electric signal S6 to the hydraulic pressure control apparatus 6, and shifts the solenoid valve SLC3 to OFF. At this time, the first and the second selector valves 23, 24 shift and maintain the solenoid valve to the side communicated with the hydraulic servo B-2.

Accordingly, at the solenoid valve SLC3, a supply of the line pressure P_{L} to the hydraulic servo C-3 is blocked and, simultaneously the engagement pressure P_{C3} of this hydraulic servo is communicated with the drain, so that the torque capacity of the clutch C-3 is reduced (F12). In this state, the clutch C-3 is released, and the shaft torque of the output shaft is also released. After having determined the state in which the shaft torque of the output shaft is released (F13), the range selection control unit U1 outputs the P range electric signal S2 to the motor 32 of the driving mechanism 35 after the predetermined delay time t₂ on the basis of the delay unit U1a.

The delay unit U1a selects the predetermined delay time t₂ which is set in advance by the map on the basis of the oil temperatures, the invention is not limited thereto, and, for example, the hydraulic pressure of the hydraulic servo C-3 may be detected or, alternatively, other means such as detecting the rotation of the output shaft may be employed.

Then, on the basis of the signal S2 after having determined that the delay time is enough to cause the shaft torque of the output shaft to be released by the delay unit U1a, the driving mechanism 35 is driven to the P range, the manual valve 20 is moved to the P-range position and, simultaneously, the parking rod 55 of the parking activating mechanism 53 is moved integrally therewith. Then, the manual valve 20 shifts the R range port from the line pressure supply to the drain and, simultaneously, the parking cam 56 is moved via the spring 57, and the cam 56 is clamped between the support 62 and the parking pole 61 to cause the parking pole 61 to engage the parking gear 60, so that the output shaft is locked to the stop state (F14).

In this state, even when the shaft torque is applied to the output shaft in the reverse state, the output shaft is released by releasing the clutch C-3 and then the output shaft is locked, so that a shock (P-release shock) due to the shift to the parking (P) range does not occur. Since the reverse (R) range pressure P_{R} is released by the shift of the manual valve 20 to the P range, the engagement pressure P_{B2} of the brake hydraulic servo B-2 is released via the second selector valve 24, so that the P-range is assumed (F15).

Although the description given above is about the shift of D->N range and R->P range, it may be applied to other range shift such as R->N range.

The present invention relates to a range (P, R, N, D, and the like) selection apparatus on the basis of a shift-by-wire system used for a multi-stage automatic transmission or a stepless automatic transmission mounted on an automotive vehicle, and configured to transmit the intention of an operating side such as a shift lever to an activated side as an electric signal.

What is claimed is:

1. A range selection apparatus comprising:
a range operating unit being able to select a range and issue an instruction of the same,
a drive unit configured to receive each range selected by the range operating unit transmitted via an electric signal, and
a range selection activating unit configured to be shifted to a position corresponding to the each range by the drive unit, wherein
a range selection control unit is interposed in a transmission from the range operating unit to the drive unit via an electric signal, and
the range selection control unit includes a delay unit configured to issue a signal which activates directly at least one of two activating elements required when shifting to a predetermined range via an automatic transmission control unit and issue the signal for causing the shift to the predetermined range to the drive unit after having provided the other one of the activating elements with a delay time enough for the one of the activating elements to be activated.

2. The range selection apparatus according to claim 1, wherein the activating elements are two engaging elements configured to shift a power transmission path of the automatic transmission,
the range selection activating unit is a manual valve,
the one of the two engagement unit is directly shifted on the basis of the electric signal from the automatic transmission control unit, and
the other one of the two engaging elements is shifted by shifting the manual valve by driving the drive unit after having elapsed the delay time by the delay unit.

3. The range selection apparatus according to claim 2, wherein
the range operated by the range operating unit is a shift from a D range to an N range,
the two engaging elements are a first clutch and a first brake engaged at a forward second gear speed,
an engagement pressure of the first clutch is drained by a linear solenoid valve directly on the basis of an N range electric signal from the range operating unit,
the engagement pressure of the first brake is drained by the manual valve after the first clutch does not have a torque capacity any longer on the basis of the delay time by the delay unit.

4. The range selection apparatus according to claim 1, wherein
the range operated by the range operating unit is a shift from an R range to a P range,
the range selection operating unit is a parking activating mechanism moved in association with the manual valve,
the one of the activating elements is at least one engaging element which engages in the R range, and the other one is a parking lock unit configured to stop an output shaft of the automatic transmission in the P range,
an engagement pressure of the engaging element which engages in the R range is drained by a linear solenoid valve directly on the basis of a P range electric signal from the range operating unit, and
the parking lock unit locks the output shaft by the parking activating mechanism after a shaft torque of the output shaft is released by the release of the engaging element on the basis of the delay time by the delay unit.
